(19) United States
(12) Patent Application Publication
(10) Pub. No.: US 2005/0180421 A1
(43) Pub. Date: Aug. 18, 2005

(54) Source address-fabricated packet detection unit, source address-fabricated packet detection method, and source address-fabricated packet detection program

(75) Inventors: Kuniaki Shimada, Kawasaki (JP); Tetsuya Okano, Kawasaki (JP); Ken Yokoyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/094,247

(22) Filed: Mar. 31, 2005

Related U.S. Application Data
(63) Continuation of application No. PCT/JP02/12583, filed on Dec. 2, 2002.

(51) Int. Cl. H04L 12/56

(52) U.S. Cl. 370/389

(57) ABSTRACT

A source address-fabricated packet detection unit that detects a packet with a fabricated source IP address comprises a packet controller that controls the input/output of a packet and acquires a source IP address and TTL value of the input packet; a reference TTL value storage section that stores a reference TTL value that represents a normal time to live range and source address in a correspondence manner; and an address fabrication determination section that compares the TTL value of the input packet and reference TTL value corresponding to the source IP address of the input packet to determine the presence or absence of the fabrication of the source IP address in the input packet based on the comparison result.

### BACKGROUND OF THE INVENTION

1. Field of the Invention

The present invention relates to a source address-fabricated packet detection unit, a source address-fabricated packet detection method, and a source address-fabricated packet detection program that detect the hacking or attacks carried out by fabricating a source address in an FW (Fire Wall), a router with a filtering function, or an IDS (Intruder Detection System) on a network.

2. Description of the Related Art

Currently, with the spread of a packet communication service in WWW (World Wide Web), E-mail, mobile phone, the Internet becomes a social infrastructure. Under the circumstances, a highly sophisticated security function has been demanded. To satisfy the demand, many products such as an FW, and IDS, that perform protection against the hacking or attacks becomes widespread. Of the hacking or attacks, what is seriously troubling is a fabrication of a source address of a packet.

Here, an operation of the FW in TCP (Transmission Control Protocol)/IP (Internet Protocol) network boundary will be described. FIG. 16 shows an example of the operation of the FW. In FIG. 16, the inside of LAN (Local Area Network) where hosts 102 and 103 exist and the outside of LAN where a host 101 exists are connected to each other through an FW 100. For simplicity of explanation, the IP address of the host 101 is assumed to be A, the IP address of the host 102 is assumed to be B, and the IP address of the host 103 is assumed to be C. The host 102 and host 103 are in a confidential relationship. They use only authentication of the source IP address. For example, an rsh (remote shell) in UNIX system OS writes a specified host name or a source IP address in ˜/.rhosts file to establish a confidential relationship. The host whose name has been specified can make an access to the system without a password.

When the host 101 falsely replaces the source IP address in the IP header of the packet to be sent with the IP address B of the host 102, the packet sent from the host 101 has been regarded as the packet sent from the host 102, with the result that, the host 101 can access the host 103 through the FW 100 and illegally use the host 103.

As a means for preventing the illegal intrusion of the source address-fabricated packet, a filtering function of the FW can be taken. More specifically, the FW determines whether the source IP address of the packet directed from the outside to the inside of LAN corresponds to the IP address of the host existing in the inside of LAN. When determining the source IP address of the packet directed from the outside to the inside of LAN is the IP address of the host existing in the inside of LAN, the FW discards the sent packet. However, although such a filtering function of the FW can detect the packet in which the IP address has been falsely replaced with the host existing in the inside of LAN, but cannot detect the packet in which the IP address has been falsely replaced with the host existing outside of LAN.

On the other hand, some FWs have a filtering passage list. The filtering passage list is a list that describes source IP addresses that are allowed to be passed from the outside to the inside of LAN. FIG. 17 shows an example of the operation of the FW having the filtering passage list. In the example of FIG. 17, the host 102 having a confidential relationship with the host 103 exists outside of LAN. The inside of LAN where host 103 exists and the outside of LAN where hosts 101 and 102 exist are connected to each other through an FW 110. As the source IP address of a packet that is allowed to be passed through the FW 110, B is listed in the filtering passage list. As shown in FIG. 17, according to the filtering passage list, the FW 1 10 allows the packet from the host 102 having the source IP address B to be passed through but discards the packet from the host 101 having the source IP address A.

However, in the configuration shown in FIG. 17, when the host 101 falsely replaces the source IP address in the IP header of the packet to be sent with the IP address B of the host 102, the FW 110 does not discard the packet from the host 101 having the source IP address B, but allows the same to be passed through.

### SUMMARY OF THE INVENTION

The present invention has been made to solve the above problem, and an object thereof is to provide a source IP address-fabricated packet detection unit, a source IP address-fabricated packet detection method, and a source IP address-fabricated packet detection program capable of detecting a packet in which the IP address has been falsely replaced with the source IP address of the host existing outside of LAN and thereby protecting the inside of LAN from the hacking or attacks carried out by fabricating a source IP address,

According to a first aspect of the present invention, there is provided a source address-fabricated packet detection unit that detects a packet with a fabricated source address, comprising: a packet controller that controls the input/output of a packet and acquires a source address and time to live of the input packet; a reference time to live storage section that stores a reference time to live that represents a normal time to live range and source address in a correspondence manner; and an address fabrication determination section that compares the time to live of the input packet and reference time to live corresponding to the source address of the input packet to determine the presence or absence of the fabrication of the source address in the input packet based on the comparison result.

With the above configuration, it is possible to detect the packet with a fabricated source address by comparing the reference time to live for each source address that has been previously stored and the time to live of the input packet.

The source address-fabricated packet detection unit according to the present invention further comprises: a time to live storage section that stores the source address of the input packet and time to live in a correspondence manner; and a reference time to live calculation section that calculates a reference time to live for each source address based on the time to live that the time to live storage section has stored for each source address.

With the above configuration, it is possible to calculate the reference time to live for each source address by using the time to live collected for each source address.

In the source address-fabricated packet detection unit according to the present invention, when the address fabrication determination section has determined the absence of the source address fabrication, the packet controller allows the input packet to be passed through, and when the address fabrication determination section has determined the presence of the source address fabrication, the packet controller discards the input packet.

With the above configuration, it is possible to protect, in real time, the inside of LAN from the hacking or attacks carried out by fabricating the source address by discarding the address fabricated packet when detected.

The source address-fabricated packet detection unit according to the present invention further comprises a disconnection section that disconnects the connection between the source address and destination address of the input packet when the address fabrication determination section has determined the presence of the source address fabrication.

With the above configuration, when the source address-fabricated packet is detected, the fabricated packet is discarded. Further, the connection between the source address and destination address is disconnected. Therefore, it is possible to protect, in real time, the inside of LAN from the hacking or attacks carried out by fabricating the source address and prevent the continuation of the hacking or attacks.

The source address-fabricated packet detection unit according to the present invention further comprises an alert information notification section that sends alert information to an address that has been previously designated when the address fabrication determination section has determined the presence of the source address fabrication.

With the above configuration, when the source address-fabricated packet is detected, alert information related to the packet is notified to an administrator. Therefore, the administrator can grasp the hacking or attacks carried out by fabricating the source address and cope with it.

The source address-fabricated packet detection unit according to the present invention further comprises a log storage section that stores alert information as a log when the address fabrication determination section has determined the presence of the source address fabrication.

With the above configuration, when the source address-fabricated packet is detected, alert information related to the packet is recorded as a log. Therefore, it is possible to preserve the records of the hacking or attacks carried out by fabricating the source address and use the log as evidence of the hacking or attacks.

In the source address-fabricated packet detection unit according to the present invention, the source address is a source IP address, the time to live is a TTL value, the reference time to live is a reference TTL value representing a normal TTL value range, and the reference time to live storage section is a reference TTL value storage section.

With the above configuration, it is possible to detect the packet having a fabricated source IP address by comparing the reference TTL value for each source IP address that has been previously stored and the TTL value of the input packet.

The source address-fabricated packet detection unit according to the present invention further comprises: a TTL value storage section that stores the source IP address of the input packet and TTL value in a correspondence manner; and a reference TTL value calculation section that calculates a reference TTL value for each source IP address based on the TTL value that the TTL value storage section has stored for each source IP address. Further, in the source address-fabricated packet detection unit according to the present invention, the reference TTL value calculation section calculates a median value from the TTL value that the TTL value storage section has stored for each source IP address and sets a predetermined range including the median value as the reference TTL value corresponding to the source IP address. Further, in the source address-fabricated packet detection unit according to the present invention, the reference TTL value calculation section calculates an average value from the TTL value that the TTL value storage section has stored for each source IP address and sets a predetermined range including the average value as the reference TTL value corresponding to the source IP address.

With the above configuration, it is possible to calculate the reference TTL value for each source IP address by using the TTL value collected for each source IP address.

In the source address-fabricated packet detection unit according to the present invention, when the address fabrication determination section has determined the absence of the source IP address fabrication, the packet controller allows the input packet to be passed through, and when the address fabrication determination section has determined the presence of the source IP address fabrication, the packet controller discards the input packet.

With the above configuration, it is possible to protect, in real time, the inside of LAN from the hacking or attacks carried out by fabricating the source IP address by discarding the source IP address-fabricated packet when detected.

The source address-fabricated packet detection unit according to the present invention further comprises a disconnection section that disconnects the connection between the source IP address and destination IP address of the input packet when the address fabrication determination section has determined the presence of the source IP address fabrication. In the source address-fabricated packet detection unit according to the present invention, the disconnection section sends a reset packet to the source IP address and destination IP address to disconnect the connection between the source IP address and destination IP address.

With the above configuration, when the source IP address-fabricated packet is detected, the fabricated packet is discarded. Further, the connection between the source IP address and destination IP address is disconnected. Therefore, it is possible to protect, in real time, the inside of LAN from the hacking or attacks carried out by fabricating the source IP address and prevent the continuation of the hacking or attacks.

The source address-fabricated packet detection unit according to the present invention further comprises an alert information notification section that sends alert information to an address that has been previously designated when the address fabrication determination section has determined the presence of the source IP address fabrication. In the source address-fabricated packet detection unit according to the present invention, the alert information includes the source IP address, destination IP address, and TTL value of the input packet and reference TTL value.

With the above configuration, when the source IP address-fabricated packet is detected, alert information related to the packet is notified to an administrator. Therefore, the administrator can grasp the hacking or attacks carried out by fabricating the source IP address and cope with it. Note that the alert information may further include date and time.

The source address-fabricated packet detection unit according to the present invention further comprises a log storage section that stores alert information as a log when the address fabrication determination section has determined the presence of the source IP address fabrication. In the source address-fabricated packet detection unit according to the present invention, the alert information includes the source IP address, destination IP address, and TTL value of the input packet and reference TTL value.

With the above configuration, when the source IP address-fabricated packet is detected, alert information related to the packet is recorded as a log. Therefore, it is possible to preserve the records of the hacking or attacks carried out by fabricating the source IP address and use the log as evidence of the hacking or attacks.

According to a second aspect of the present invention, there is provided a source address-fabricated packet detection method for detecting a packet having a fabricated source IP address, comprising: controlling the input/output of a packet and acquiring a source IP address and TTL value of the input packet; storing the source IP address and TTL vale of the input packet in a correspondence manner; calculating the reference TTL value that represents a normal TTL value range for each source IP address based on the TTL value stored for each source IP address; storing the reference TTL value and source IP address in a correspondence manner; and comparing the TTL value of the input packet with the reference TTL value corresponding to the source IP address of the input packet to determine whether the source IP address in the input packet has been fabricated or not based on the comparison result.

With the above configuration, it is possible to detect the packet with a fabricated source IP address by comparing the reference TTL value for each source address calculated using the TTL value collected for each source IP address and the TTL value of the input packet.

The source address-fabricated packet detection method according to the present invention further comprises: allowing the input packet to be passed through when it has been determined that the source IP address has not been fabricated; and discarding the input packet when it has been determined that the source IP address has been fabricated.

With the above configuration, it is possible to protect, in real time, the inside of LAN from the hacking or attacks carried out by fabricating the source IP address by discarding the source IP address-fabricated packet when detected.

The source address-fabricated packet detection method according to the present invention further comprises disconnecting the connection between the source IP address and destination IP address of the input packet when it has been determined that the source IP address has been fabricated.

With the above configuration, when the source IP address-fabricated packet is detected, the fabricated packet is discarded. Further, the connection between the source IP address and destination IP address is disconnected. Therefore, it is possible to protect, in real time, the inside of LAN from the hacking or attacks carried out by fabricating the source IP address and prevent the continuation of the hacking or attacks.

The source address-fabricated packet detection method according to the present invention further comprises sending alert information to an address that has been previously designated when it has been determined that the source IP address has been fabricated.

With the above configuration, when the source IP address-fabricated packet is detected, alert information related to the packet is notified to an administrator. Therefore, the administrator can grasp the hacking or attacks carried out by fabricating the source IP address and cope with it.

The source address-fabricated packet detection method according to the present invention further comprises storing alert information as a log when it has been determined that the source IP address has been fabricated.

With the above configuration, when the source IP address-fabricated packet is detected, alert information related to the packet is recorded as a log. Therefore, it is possible to preserve the records of the hacking or attacks carried out by fabricating the source IP address and use the log as evidence of the hacking or attacks.

According to a third aspect of the present invention, there is provided a source address-fabricated packet detection program that has been stored in a computer-readable medium in order to allow a computer to detect the packet with a fabricated source IP address, comprising: controlling the input/output of a packet and acquiring a source IP address and TTL value of the input packet; storing the source IP address and TTL value of the input packet in a correspondence manner; calculating the reference TTL value that represents a normal TTL value range for each source IP address based on the TTL value stored for each source IP address; storing the reference TTL value and source IP address in a correspondence manner; and comparing the TTL value of the input packet with the reference TTL value corresponding to the source IP address of the input packet to determine whether the source IP address in the input packet has been fabricated or not based on the comparison result.

With the above configuration, it is possible to detect the packet with a fabricated source IP address by comparing the reference TTL value for each source address calculated using the TTL value collected for each source IP address and the TTL value of the input packet.

The source address-fabricated packet detection program according to the present invention further comprises: allowing the input packet to be passed through when it has been determined that the source IP address has not been fabricated; and discarding the input packet when it has been determined that the source IP address has been fabricated.

With the above configuration, it is possible to protect, in real time, the inside of LAN from the hacking or attacks carried out by fabricating the source IP address by discarding the source IP address-fabricated packet when detected.

The source address-fabricated packet detection program according to the present invention further comprises disconnecting the connection between the source IP address and destination IP address of the input packet when it has been determined that the source IP address has been fabricated.

With the above configuration, when the source IP address-fabricated packet is detected, the fabricated packet is discarded. Further, the connection between the source IP address and destination IP address is disconnected. Therefore, it is possible to protect, in real time, the inside of LAN from the hacking or attacks carried out by fabricating the source IP address and prevent the continuation of the hacking or attacks.

The source address-fabricated packet detection program according to the present invention further comprises sending alert information to an address that has been previously designated when it has been determined that the source IP address has been fabricated.

With the above configuration, when the source IP address-fabricated packet is detected, alert information related to the packet is notified to an administrator. Therefore, the administrator can grasp the hacking or attacks carried out by fabricating the source IP address and cope with it.

The source address-fabricated packet detection program according to the present invention further comprises storing alert information as a log when it has been determined that the source IP address has been fabricated.

With the above configuration, when the source IP address-fabricated packet is detected, alert information related to the packet is recorded as a log. Therefore, it is possible to preserve the records of the hacking or attacks carried out by fabricating the source IP address and use the log as evidence of the hacking or attacks.

### BRIEF DESCRIPTION OF THE DRAWINGS

FIG. 1 is a view showing a packet structure;

FIG. 2 is a view showing an IP header structure;

FIG. 3 is a block diagram showing a functional configuration of a source IP address-fabricated packet detection unit according to a first embodiment;

FIG. 4 is a flowchart showing processes that the source IP address-fabricated packet detection unit according to the first embodiment performs;

FIG. 5 shows a reference TTL value table;

FIG. 6 shows a TTL value table;

FIG. 7 is a block diagram showing an operation of an FW provided with the source address-fabricated packet detection unit according to the first embodiment;

FIG. 8 is a block diagram showing a functional configuration of a source IP address-fabricated packet detection unit according to a second embodiment;

FIG. 9 is a view showing a TCP header structure;

FIG. 10 is a flowchart showing processes that the source IP address-fabricated packet detection unit according to the second embodiment performs;

FIG. 11 is a block diagram showing a functional configuration of a source IP address-fabricated packet detection unit according to a third embodiment;

FIG. 12 is a flowchart showing processes that the source IP address-fabricated packet detection unit according to the third embodiment performs;

FIG. 13 is a table showing an example of log entries;

FIG. 14 is a block diagram showing a functional configuration of a source IP address-fabricated packet detection unit according to a fourth embodiment;

FIG. 15 is a flowchart showing processes that the source IP address-fabricated packet detection unit according to the fourth embodiment performs;

FIG. 16 is a view showing an operation of the FW; and

FIG. 17 is a view showing an operation of the FW having a filtering passage list.

### DETAILED DESCRIPTION OF THE PREFERRED EMBODIMENTS

Embodiments of the present invention will be described below in detail with reference to the accompanying drawings. In the present embodiment, a description will be given of a source address-fabricated packet detection unit in a TCP/IP network.

[First Embodiment]

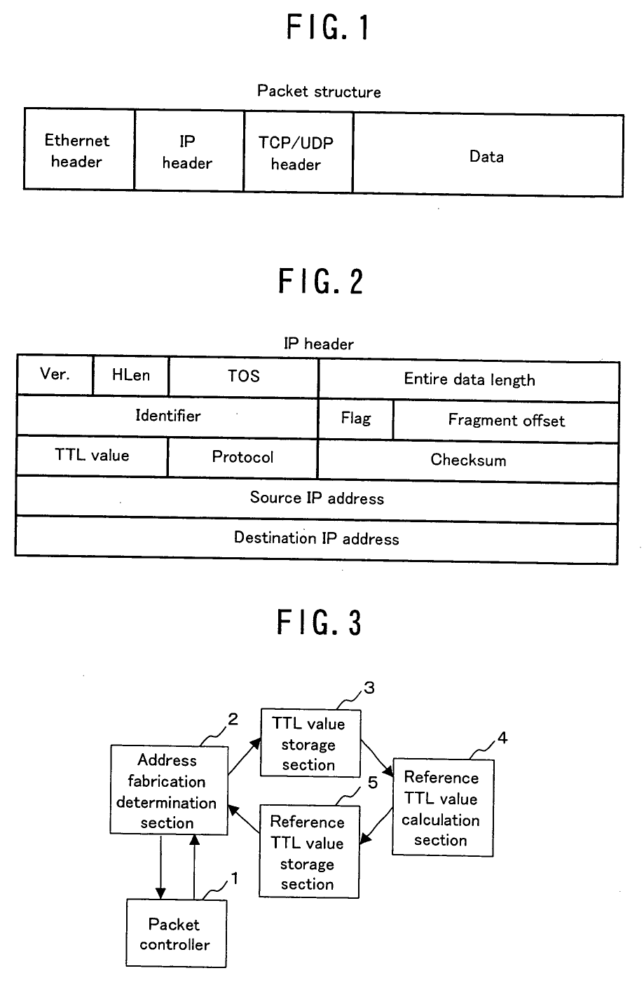

Firstly, a TTL value that a source address-fabricated packet detection unit uses will be described. As shown in FIG. 1, a packet includes Ethernet header. IP header, TCP/UDP (User Datagram Protocol) header, and data. As shown in FIG. 2, an IP header includes Ver. (Version), HLen (Header Length), TOS (Type of Service), entire data length, identifier, flag, fragment offset, TTL (Time To Live) value, protocol, checksum, source IP address, and destination IP address.

The TTL value in the IP header is a Time To Live field of the IP header and indicates the threshold limit of the router number that a packet can be passed through. An initial value is set as the TTL value at first and the value is decremented by one every time the packet is passed through a router. When the TTL value has become 0, the packet is discarded and an ICMP type 11 error (time exceeded) packet is sent back.

Under the above operation condition, the TTL value of the packet falsely assuming the source IP address often differs from the TTL value of a normal packet. The reason is that the initial value of the TTL value often differs for each host, and that the number of hops from the source host to FW often differs between the two packets. The present invention takes advantages of this nature and compares the TTL value of the passed packet and a reference TTL value to detect the source IP address-fabricated packet. The reference TTL value is calculated based on the history of the TTL value corresponding to a source IP address and denotes a normal TTL value range. A source IP address-fabricated packet detection unit according to the present embodiment will be described below in detail. The source IP address-fabricated packet detection unit according to the present embodiment discards the source IP address-fabricated packet when detected.

FIG. 3 is a block diagram showing a functional configuration of a source IP address-fabricated packet detection unit according to the first embodiment. As shown in FIG. 3, the source IP address-fabricated packet detection unit functionally includes a packet controller 1, an address fabrication determination section 2, a TTL value storage section 3, a reference TTL value calculation section 4 and a reference TTL value storage section 5.

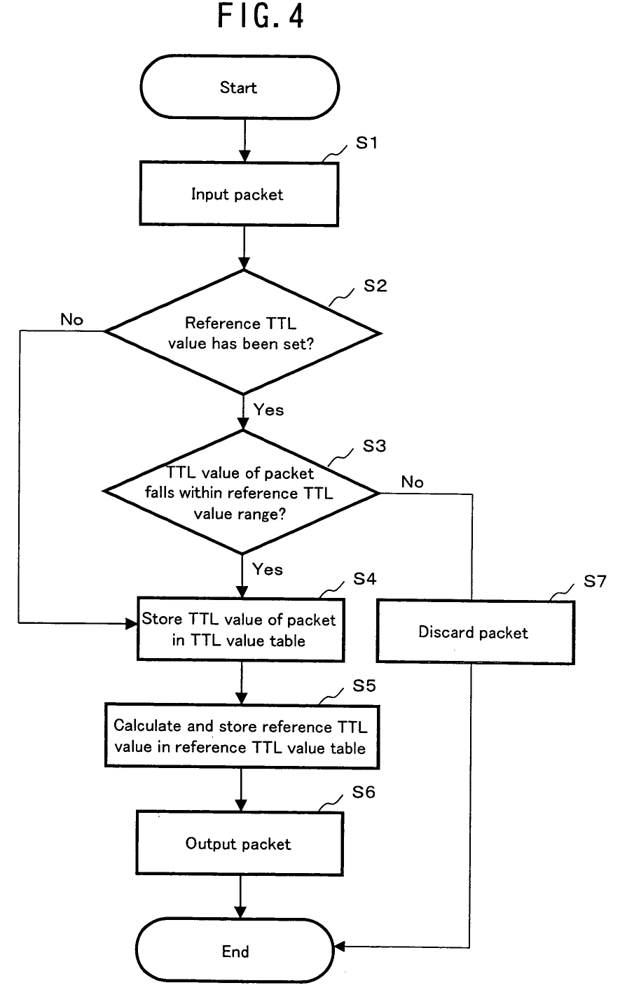

FIG. 4 is a flowchart showing processes that the source IP address-fabricated packet detection unit according to the first embodiment performs. At first, the packet controller 1 receives an input packet from a network, acquires a source IP address and TTL value from the IP header of the input packet and outputs them to the address fabrication determination section 2 (S1).

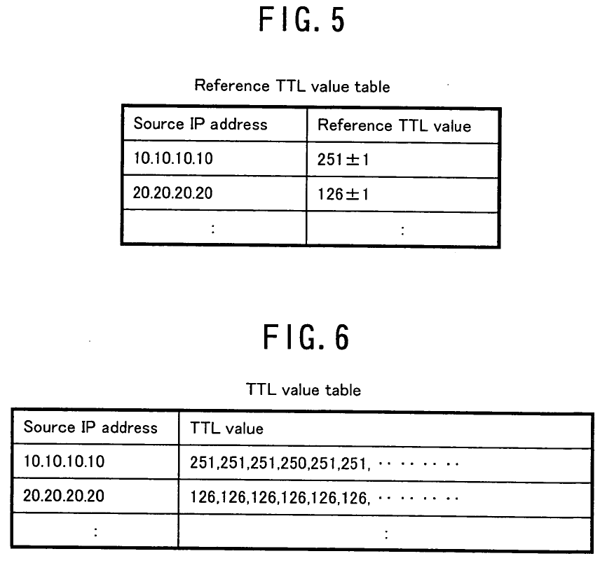

The address fabrication determination section 2 determines whether the reference TTL value corresponding to the source IP address of the input packet has been set in a reference TTL value table or not (S2). Here, the reference TTL value table will be described. The reference TTL value table is stored in the reference TTL value storage section 5. FIG. 5 shows an example of the reference TTL value table. As shown in FIG. 5, the reference TTL value table stores reference TTL values indicating a normal TTL value range for each source IP address in correspondence with the respective source IP addresses.

When the reference TTL value table does not include the reference TTL value corresponding to the source IP address of the input packet (N in S2), the flow shifts to S4. When the reference TTL value table includes the reference TTL value corresponding to the source IP address of the input packet (Y in S2), the address fabrication determination section 2 acquires the reference TTL value corresponding to the source IP address from the reference TTL value table and determines whether the TTL value of the input packet falls within reference TTL value range or not (S3).

When the TTL value of the input packet is out of reference TTL value range (N in S3), the address fabrication determination section 2 notifies the packet controller 1 that the input packet is a source IP address-fabricated packet. When receiving the notification, the packet controller 1 discards the input packet (S7) and ends the flow.

When the TTL value of the input packet falls within reference TTL value range (Y in S3), the address fabrication determination section 2 notifies the packet controller 1 that the source IP address of the input packet is normal and stores the TTL value of the input packet in the TTL value table (S4).

Here, the TTL table will be described. The TTL value table is stored in the TTL value storage section 3. FIG. 6 is a view showing an example of the TTL value table. As shown in FIG. 6, the TTL value table stores the TTL values collected for each source IP address in correspondence with the respective source IP addresses.

The reference TTL value calculation section 4 calculates the reference TTL values including the TTL values that have been newly stored in the TTL value table and stores the calculation results in the reference TTL value table (S5). The reference TTL value is calculated as a median value or average value of the TTL values for each source IP address in the TTL value table. The reference TTL value is allowed to have a range. For example, the reference TTL value can be set as “median value ±1”, or “average ±1”. It is possible to omit the TTL value storage section 3 and reference TTL value calculation 4 by allowing the reference TTL value table to store the reference TTL table previously.

When receiving the notification that the source IP address of the input packet is normal, the packet controller 1 transmits the input packet to the network (S6) and end the flow.

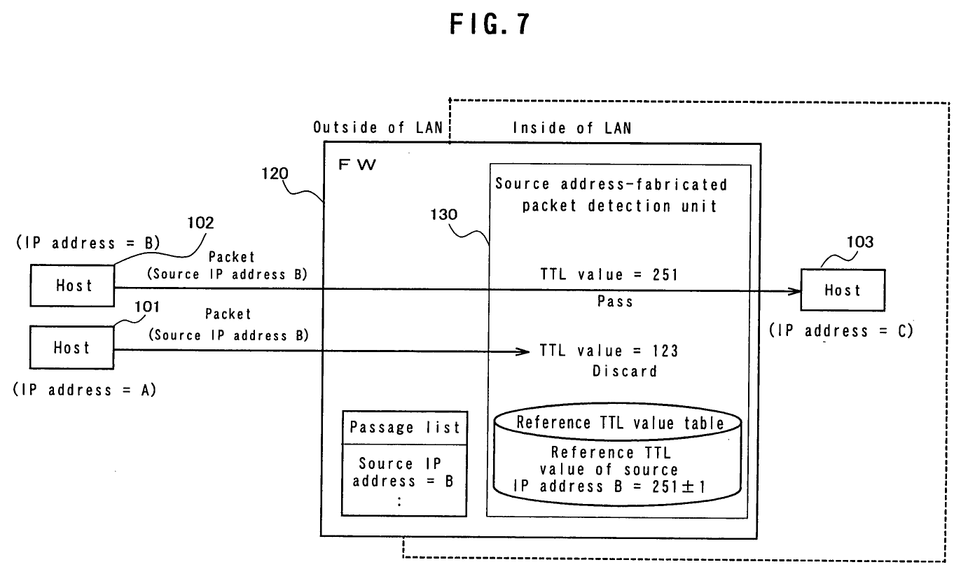

An operation example of the FW provided with the source address-fabricated packet detection unit according to the embodiment will next be described with reference to FIG. 7. FIG. 7 is a block diagram showing the operation example of the FW provided with the source address-fabricated packet detection unit according to the first embodiment. In the example shown in FIG. 7, the host 102 having a confidential relationship with the host 103 exists outside of LAN. The inside of LAN where the host 103 exists and the outside of LAN where the hosts 101 and 102 exist are connected to each other through the FW 120. Here, the IP address of the host 101 is assumed to be A, the IP address of the host 102 is assumed to be B, and the IP address of the host 103 is assumed to be C. The FW 120 holds a filtering passage list and includes the source address-fabricated packet detection unit 130 according to the present embodiment. As the source IP address that is allowed to be passed through the FW 120, B is listed in the filtering passage list.

For the sake of simplicity, only a determination made for the packet having the source IP address B will be described. The source address-fabricated packet detection unit 130 compares the TTL value of the input packet with the reference TTL value 251±1 corresponding to the source IP address of the input packet, When determining that the TTL value falls within reference TTL value range, the source address-fabricated packet detection unit 130 allows the input packet to be passed through. When determining that the TTL value is out of reference TTL value range, the source address-fabricated packet detection unit 130 discards the input packet. In the example of FIG. 7, the source IP address of the packet sent from the host 102 is B and the TTL value (251) thereof falls within reference TTL value range (251±1). Therefore, the source address-fabricated packet detection unit 130 determines that the packet sent from the host 102 is normal and allows the packet to be passed through. On the other hand, the source IP address of the packet sent from the host 101 is B but the TTL value (123) thereof is out of reference TTL value range (251±1). Therefore, the source address-fabricated packet detection unit 130 determines that the packet sent from the host 101 is a fabricated one and discards it.

As described above, in the present embodiment, when the source IP address-fabricated packet is detected, the detected packet is discarded, Therefore, it is possible to protect, in real time, the inside of LAN from the hacking or attacks carried out by fabricating the source IP address.

[Second Embodiment]

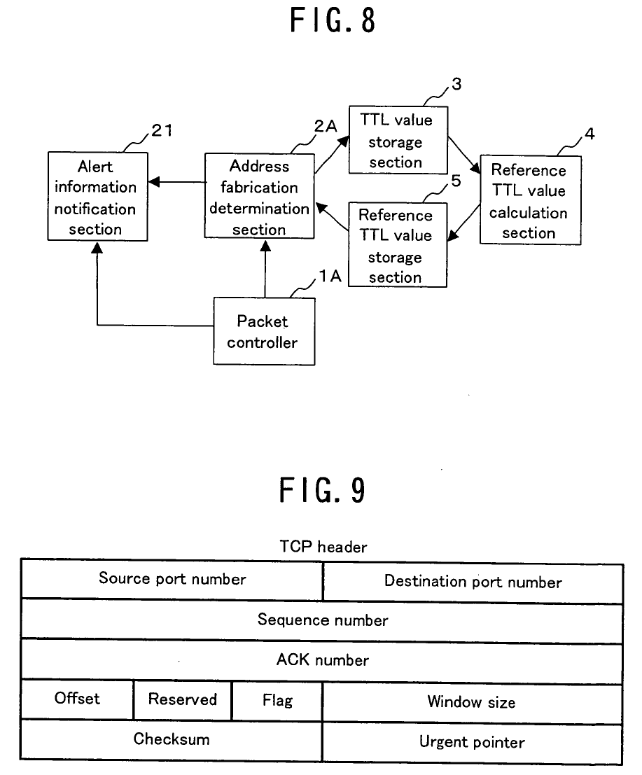

The source IP address-fabricated packet detection unit according to a second embodiment notifies an administrator of the information related to the fabricated packet when having detected the source IP address-fabricated packet. FIG. 8 is a block diagram showing a functional configuration of the source IP address-fabricated packet detection unit according to the second embodiment. In FIG. 8, the same reference numerals as those in FIG. 3 denote the same or corresponding parts as those in FIG. 3, and the descriptions thereof will be omitted here. As shown in FIG. 8, the source IP address-fabricated packet detection unit according to the present embodiment functionally includes the components shown in FIG. 3, as well as an alert information notification section 21. Further, the source IP address-fabricated packet detection unit includes a packet controller 1A and an address fabrication determination section 2A in place of the packet controller 1 and address fabrication determination section 2 in the configuration shown in FIG. 3.

At first, an operation of the packet controller 1A will be described. The packet controller 1A firstly receives an input packet from a network. Then, the packet controller 1A acquires the source IP address and TTL value of the input packet so as to output them to the address fabrication determination section 2A, and acquires connection information of the input packet so as to output it to the alert information notification section 21. After that, the packet controller 1A transmits the input packet to the network. The connection information includes a source IP address and destination IP address to be obtained from the IP header and a source port number and destination port number to be obtained from the TCP header. As shown in FIG. 9, the TCP header includes source port number, destination port number, sequence number, ACK (Acknowledge) number, offset, reserved, flag, window size, checksum, and urgent pointer.

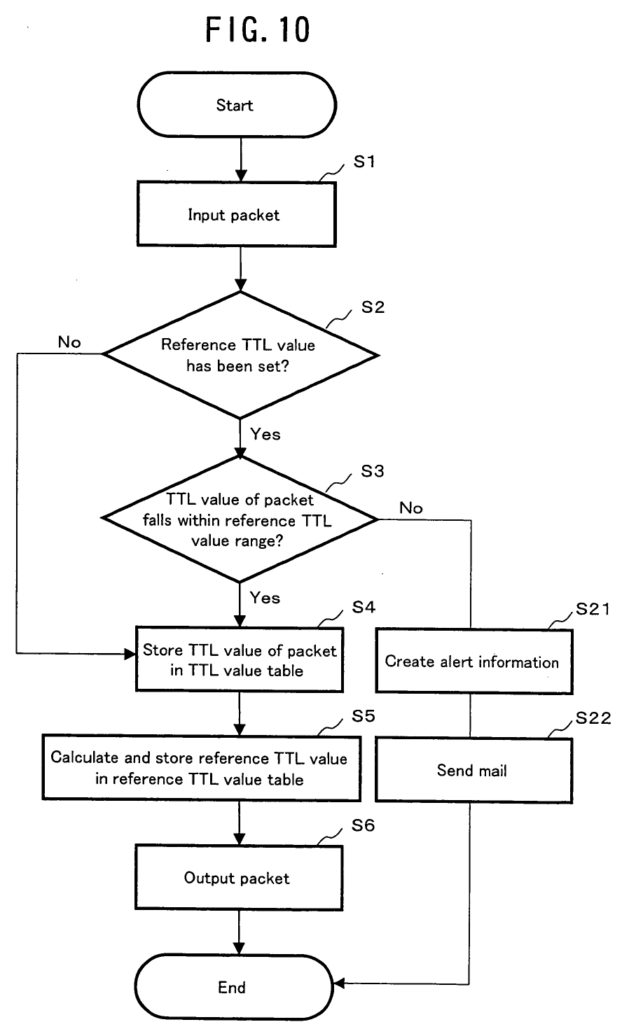

Operations of the address fabrication determination section 2A and alert information notification section 21 will next be described. FIG. 10 is a flowchart showing processes that the source IP address-fabricated packet detection unit according to the second embodiment performs. In FIG. 10, the same reference numerals as those in FIG. 4 denote the same or corresponding process as those in FIG. 4, and the descriptions thereof will be omitted here. In the present embodiment, when the TTL value of an input packet is out of reference TTL value range (N in S3), the address fabrication determination section 2A notifies the alert information notification section 21 that the input packet is a source IP address-fabricated packet. At this time, the address fabrication determination section 2A hands off the TTL value of the input packet and reference TTL value to the alert information notification section 21.

When receiving the notification that the input packet is a source IP address fabricated packet, the alert information notification section 21 creates alert information (S21). The alert information includes, for example, date, time, connection information and TTL value of the input packet, and reference TTL value. The alert information notification section 21 then sends the alert information as a mail to the mail address of a designated administrator (S22) and ends the flow.

As described above, in the present embodiment, when the source IP address-fabricated packet is detected, alert information related to the packet is created and notified to an administrator. Therefore, the administrator can grasp the hacking or attacks carried out by fabricating the source IP address and cope with it.

[Third Embodiment]

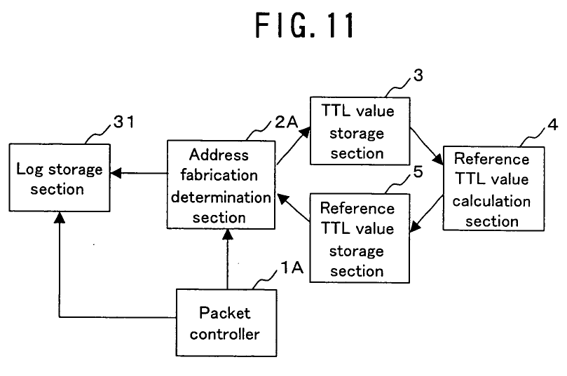

The source IP address-fabricated packet detection unit according to a third embodiment records information related to the fabricated packet as a log when having detected the source IP address-fabricated packet. FIG. 11 is a block diagram showing a functional configuration of the source IP address-fabricated packet detection unit according to the third embodiment. In FIG. 11, the same reference numerals as those in FIG. 8 denote the same or corresponding parts as those in FIG. 8, and the descriptions thereof will be omitted here. As shown in FIG. 11, the source IP address-fabricated packet detection unit according to the present embodiment functionally includes a log storage section 31 in place of the alert information notification section 21 shown in FIG. 8.

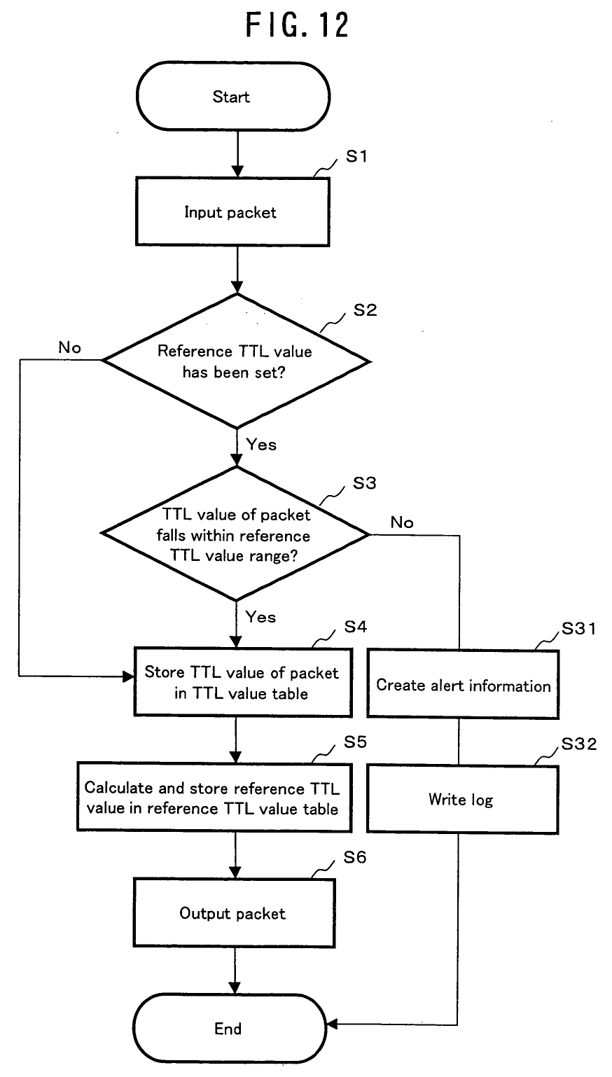

An operation of the log storage section 31 will be described. FIG. 12 is a flowchart showing processes that the source IP address-fabricated packet detection unit according to the third embodiment performs. In FIG. 12, the same reference numerals as those in FIG. 4 denote the same or corresponding process as those in FIG. 4, and the descriptions thereof will be omitted here. In the present embodiment, when the TTL value of an input packet is out of reference TTL value range (N in S3), the address fabrication determination section 2A notifies the log storage section 31 that the input packet is a source IP address-fabricated packet. At this time, the address fabrication determination section 2A hands off the TTL value of the input packet and reference TTL value to the log storage section 31.

When receiving the notification that the input packet is a source IP address fabricated packet, the log storage section 31 creates alert information (S31). The log storage section 31 then records the alert information as a log (S32) and ends the flow.

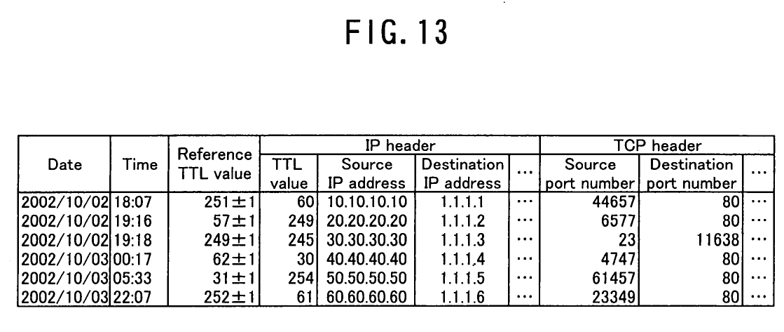

FIG. 13 shows an example of log entries. As shown in FIG. 13, a log entry includes date and time of the passage of the source IP address-fabricated packet, and the reference TTL value, TTL value, connection information of the source IP address-fabricated packet.

As described above, in the present embodiment, when the source IP address-fabricated packet is detected, alert information related to the packet is created and recorded as a log. Therefore, it is possible to preserve the records of the hacking or attacks carried out by fabricating the source IP address and use the log as evidence of the hacking or attacks.

[Fourth Embodiment]

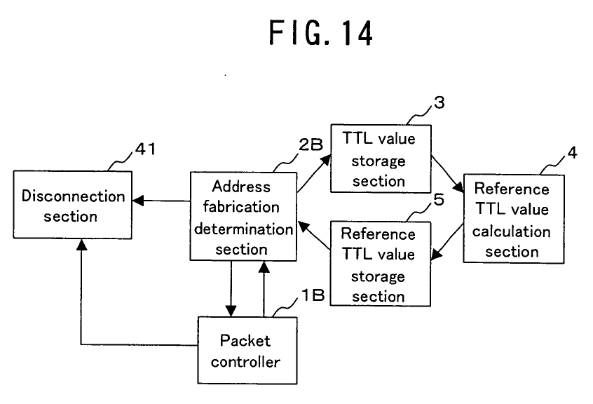

The source IP address-fabricated packet detection unit according to a fourth embodiment disconnects the connection between the source IP address and destination address of the fabricated packet when having detected the source IP address-fabricated packet. FIG. 14 is a block diagram showing a functional configuration of the source IP address-fabricated packet detection unit according to the fourth embodiment. In FIG. 14, the same reference numerals as those in FIG. 3 denote the same or corresponding parts as those in FIG. 3, and the descriptions thereof will be omitted here. As shown in FIG. 14, the source IP address-fabricated packet detection unit according to the present embodiment functionally includes the components shown in FIG. 3, as well as a disconnection section 41. Further, the source IP address-fabricated packet detection unit includes a packet controller 1B and an address fabrication determination section 2B in place of the packet controller 1 and address fabrication determination section 2 in the configuration shown in FIG. 3.

At first, an operation of the packet controller 1B will be described. The packet controller 1B firstly receives an input packet from a network. Then the packet controller 1B acquires the source IP address and TTL value of the input packet so as to output them to the address fabrication determination section 2B, and outputs the input packet to the disconnection section 41. When receiving a notification that the input packet is a source IP address-fabricated packet, the packet controller 1B discards the input packet.

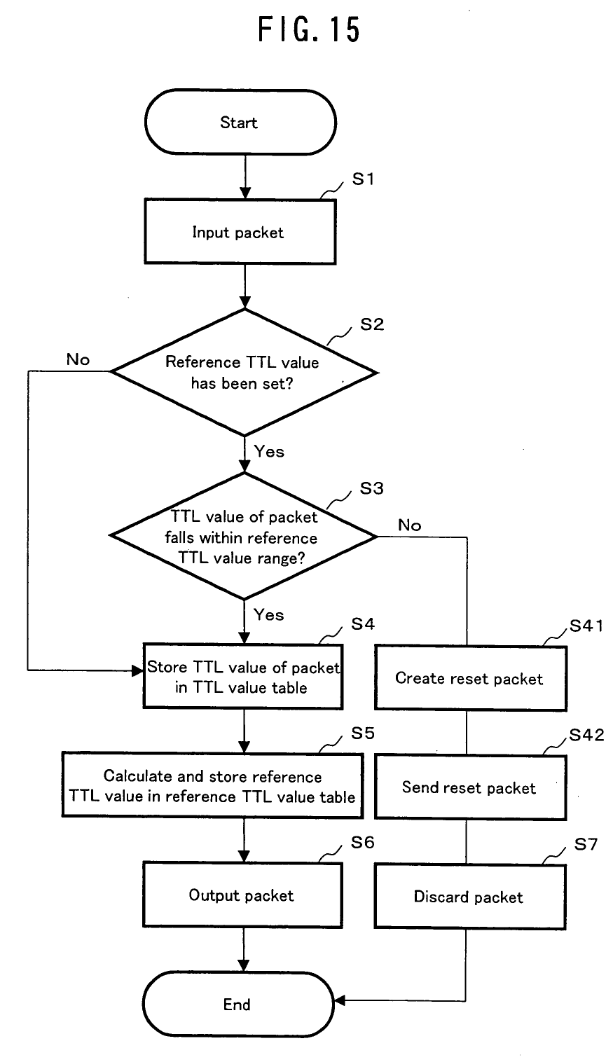

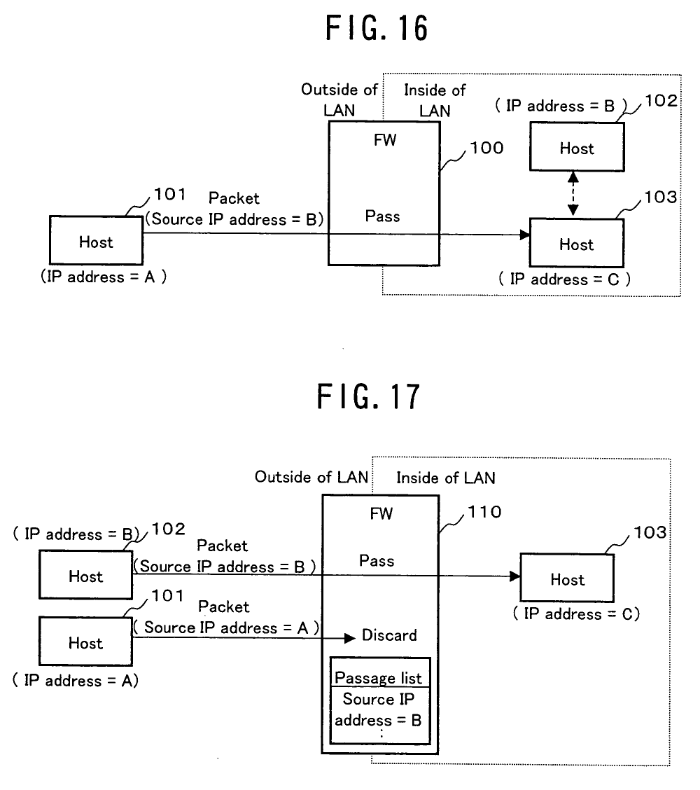

Operations of the address fabrication determination section 2B and disconnection section 41 will next be described. FIG. 15 is a flowchart showing processes that the source IP address-fabricated packet detection unit according to the fourth embodiment performs. In FIG. 15, the same reference numerals as those in FIG. 4 denote the same or corresponding process as those in FIG. 4, and the descriptions thereof will be omitted here. In the present embodiment, when the TTL value of an input packet is out of reference TTL value range (N in S3), the address fabrication determination section 2B notifies the disconnection section 41 and packet controller 1B that the input packet is a source IP address-fabricated packet.

When receiving the notification that the input packet is a source IP address-fabricated packet, the disconnection section 41 refers to the input packet and creates a reset packet for the source IP address and destination IP address (S41). The reset packet is a packet for forcibly terminating the TCP connection, more specifically, a packet that sets an RST flag bit among the flags in the TCP header. The disconnection section 41 then sends the reset packet to the source IP address and destination IP address (S42) and ends the flow.

As described above, in the present embodiment, when the source IP address-fabricated packet is detected, the fabricated packet is discarded. Further, the reset packet is created and sent to the source IP address and destination IP address to thereby disconnect the connection through TCP. Therefore, it is possible to protect, in real time, the inside of LAN from the hacking or attacks carried out by fabricating the source IP address and prevent the continuation of the hacking or attacks.

By programming the function of the source IP address-fabricated packet detection unit described in the first to fourth embodiments, it is possible to implement the function as a part of functions of the FW, router, or IDS and to allow the function to cooperate with other functions of them. It is, therefore, possible to increase the detection rate of the hacking or attacks.

According to the present invention, as described above, in a unit that relays or monitors a packet, it is possible to collect the TTL value for each source IP address of the passing packet to create the reference TTL value and to compare the TTL value of the passing packet with the reference TTL value to thereby detect the fabrication of the source IP address. Further, by creating alert information or discarding the packet when the fabrication of the source IP address has been detected, it is possible to protect the inside of LAN from the hacking or attacks carried out by fabricating a source address.

1. A source address-fabricated packet detection unit that detects a packet with a fabricated source address, comprising:
a packet controller that controls the input/output of a packet and acquires a source address and time to live of the input packet;
a reference time to live storage section that stores a reference time to live that represents a normal time to live range and source address in a correspondence manner; and
an address fabrication determination section that compares the time to live of the input packet and reference time to live corresponding to the source address of the input packet to determine the presence or absence of the fabrication of the source address in the input packet based on the comparison result.

2. The source address-fabricated packet detection unit according to claim 1, wherein
when the address fabrication determination section has determined the absence of the source address fabrication, the packet controller allows the input packet to be passed through, and when the address fabrication determination section has determined the presence of the source address fabrication, the packet controller discards the input packet.

3. The source address-fabricated packet detection unit according to claim 2, further comprising:
a disconnection section that disconnects the connection between the source address and destination address of the input packet when the address fabrication determination section has determined the presence of the source address fabrication.

4. The source address-fabricated packet detection unit according to claim 1, further comprising:
an alert information notification section that sends alert information to an address that has been previously designated when the address fabrication determination section has determined the presence of the source address fabrication.

5. The source address-fabricated packet detection unit according to claim 1, further comprising:
a log storage section that stores alert information as a log when the address fabrication determination section has determined the presence of the source address fabrication.

6. The source address-fabricated packet detection unit according to claim 1, further comprising:
a time to live storage section that stores the source address of the input packet and time to live in a correspondence manner; and
a reference time to live calculation section that calculates a reference time to live for each source address based on the time to live that the time to live storage section has stored for each source address.

7. The source address-fabricated packet detection unit according to claim 6, wherein
when the address fabrication determination section has determined the absence of the source address fabrication, the packet controller allows the input packet to be passed through, and when the address fabrication determination section has determined the presence of the source address fabrication, the packet controller discards the input packet.

8. The source address-fabricated packet detection unit according to claim 7, further comprising:
a disconnection section that disconnects the connection between the source address and destination address of the input packet when the address fabrication determination section has determined the presence of the source address fabrication.

9. The source address-fabricated packet detection unit according to claim 6, further comprising:
an alert information notification section that sends alert information to an address that has been previously designated when the address fabrication determination section has determined the presence of the source address fabrication.

10. The source address-fabricated packet detection unit according to claim 6, further comprising:
a log storage section that stores alert information as a log when the address fabrication determination section has determined the presence of the source address fabrication.

11. The source address-fabricated packet detection unit according to claim 1, wherein
the source address is a source IP address,
the time to live is a TTL value,
the reference time to live is a reference TTL value representing a normal TTL value range, and
the reference time to live storage section is a reference TTL value storage section.

12. The source address-fabricated packet detection unit according to claim 11, wherein
when the address fabrication determination section has determined the absence of the source IP address fabrication, the packet controller allows the input packet to be passed through, and when the address fabrication determination section has determined the presence of the source IP address fabrication, the packet controller discards the input packet.

13. The source address-fabricated packet detection unit according to claim 12, further comprising:
a disconnection section that disconnects the connection between the source IP address and destination IP address of the input packet when the address fabrication determination section has determined the presence of the source IP address fabrication.

14. The source address-fabricated packet detection unit according to claim 13, wherein
the disconnection section sends a reset packet to the source IP address and destination IP address to disconnect the connection between the source IP address and destination IP address.

15. The source address-fabricated packet detection unit according to claim 11, further comprising:
an alert information notification section that sends alert information to an address that has been previously designated when the address fabrication determination section has determined the presence of the source IP address fabrication.

16. The source address-fabricated packet detection unit according to claim 15, wherein
the alert information includes the source IP address, destination IP address, and TTL value of the input packet and reference TTL value.

17. The source address-fabricated packet detection unit according to claim 11, further comprising:
a log storage section that stores alert information as a log when the address fabrication determination section has determined the presence of the source IP address fabrication.

18. The source address-fabricated packet detection unit according to claim 17, wherein
the alert information includes the source IP address, destination IP address, and TTL value of the input packet and reference TTL value.

19. The source address-fabricated packet detection unit according to claim 11, further comprising:
a TTL value storage section that stores the source IP address of the input packet and TTL value in a correspondence manner; and
a reference TTL value calculation section that calculates a reference TTL value for each source IP address based on the TTL value that the TTL value storage section has stored for each source IP address.

20. The source address-fabricated packet detection unit according to claim 19, wherein
the reference TTL value calculation section calculates a median value from the TTL value that the TTL value storage section has stored for each source IP address and sets a predetermined range including the median value as the reference TTL value corresponding to the source IP address.

21. The source address-fabricated packet detection unit according to claim 19, wherein
the reference TTL value calculation section calculates an average value from the TTL value that the TTL value storage section has stored for each source IP address and sets a predetermined range including the average value as the reference TTL value corresponding to the source IP address.

22. The source address-fabricated packet detection unit according to claim 19, wherein
when the address fabrication determination section has determined the absence of the source IP address fabrication, the packet controller allows the input packet to be passed through, and when the address fabrication determination section has determined the presence of the source IP address fabrication, the packet controller discards the input packet.

23. The source address-fabricated packet detection unit according to claim 22, further comprising:
a disconnection section that disconnects the connection between the source IP address and destination IP address of the input packet when the address fabrication determination section has determined the presence of the source IP address fabrication.

24. The source address-fabricated packet detection unit according to claim 23, wherein
the disconnection section sends a reset packet to the source IP address and destination IP address to disconnect the connection between the source IP address and destination IP address.

25. The source address-fabricated packet detection unit according to claim 19, further comprising:
an alert information notification section that sends alert information to an address that has been previously designated when the address fabrication determination section has determined the presence of the source IP address fabrication.

26. The source address-fabricated packet detection unit according to claim 25, wherein
the alert information includes the source IP address, destination IP address, and TTL value of the input packet and reference TTL value.

27. The source address-fabricated packet detection unit according to claim 19, further comprising:
a log storage section that stores alert information as a log when the address fabrication determination section has determined the presence of the source IP address fabrication.

28. The source address-fabricated packet detection unit according to claim 27, wherein
the alert information includes the source IP address, destination IP address, and TTL value of the input packet and reference TTL value.

29. A source address-fabricated packet detection method for detecting a packet with a fabricated source address, comprising:
controlling the input/output of a packet and acquiring a source IP address and TTL value of the input packet;
storing the source IP address and TTL vale of the input packet in a correspondence manner;
calculating the reference TTL value that represents a normal TTL value range for each source IP address based on the TTL value stored for each source IP address;
storing the reference TTL value and source IP address in a correspondence manner; and
comparing the TTL value of the input packet with the reference TTL value corresponding to the source IP address of the input packet to determine whether the source IP address in the input packet has been fabricated or not based on the comparison result.

30. The source address-fabricated packet detection method according to claim 29, further comprising:
allowing the input packet to be passed through when it has been determined that the source IP address has not been fabricated; and
discarding the input packet when it has been determined that the source IP address has been fabricated.

31. The source address-fabricated packet detection method according to claim 30, further comprising:
disconnecting the connection between the source IP address and destination IP address of the input packet when it has been determined that the source IP address has been fabricated.

32. The source address-fabricated packet detection method according to claim 29, further comprising:
sending alert information to an address that has been previously designated when it has been determined that the source IP address has been fabricated.

33. The source address-fabricated packet detection method according to claim 29, further comprising:
storing alert information as a log when it has been determined that the source IP address has been fabricated.

34. A source address-fabricated packet detection program that has been stored in a computer-readable medium in order to allow a computer to detect the packet having a fabricated source IP address, comprising:
controlling the input/output of a packet and acquiring a source IP address and TTL value of the input packet;
storing the source IP address and TTL value of the input packet in a correspondence manner;
calculating the reference TTL value that represents a normal TTL value range for each source IP address based on the TTL value stored for each source IP address;
storing the reference TTL value and source IP address in a correspondence manner; and
comparing the TTL value of the input packet with the reference TTL value corresponding to the source IP address of the input packet to determine whether the source IP address in the input packet has been fabricated or not based on the comparison result.

35. The source address-fabricated packet detection program according to claim 34, further comprising:
allowing the input packet to be passed through when it has been determined that the source IP address has not been fabricated; and
discarding the input packet when it has been determined that the source IP address has been fabricated.

36. The source address-fabricated packet detection program according to claim 35, further comprising:
disconnecting the connection between the source IP address and destination IP address of the input packet when it has been determined that the source IP address has been fabricated.

37. The source address-fabricated packet detection program according to claim 34, further comprising:
sending alert information to an address that has been previously designated when it has been determined that the source IP address has been fabricated.

38. The source address-fabricated packet detection program according to claim 34, further comprising:
storing alert information as a log when it has been determined that the source IP address has been fabricated.
